(19) United States
(12) Patent Application Publication
(10) Pub. No.: US 2022/0043776 A1
(43) Pub. Date: Feb. 10, 2022

(54) METADATA MANAGEMENT PROGRAM AND INFORMATION PROCESSING APPARATUS

(71) Applicant: FUJITSU LIMITED, Kawasaki-shi (JP)

(72) Inventor: Takuya Okamoto, Yokohama (JP)

(73) Assignee: FUJITSU LIMITED, Kawasaki-shi (JP)

(21) Appl. No.: 17/348,795

(22) Filed: Jun. 16, 2021

(30) Foreign Application Priority Data
Aug. 6, 2020 (JP) 2020-133618

(51) Int. Cl. G06F 16/178; G06F 16/182; G06F 16/16

(52) U.S. Cl. CPC G06F 16/178; G06F 16/162; G06F 16/182

(57) ABSTRACT

A computer-readable storage medium stores a metadata management program that controls a distributed file system of metadata of a directory and a file. The program causes a computer to execute a process including, managing metadata of a first directory by a first metadata management device, and copying the metadata of the first directory from the first metadata management device to a second metadata management device in a case where the second metadata management device creates and manages metadata of a second directory or a first file under the first directory.

### CROSS-REFERENCE TO RELATED APPLICATION

This application is based upon and claims the benefit of priority of the prior Japanese Patent Application No. 2020-133618, filed on Aug. 6, 2020, the entire contents of which are incorporated herein by reference.

### FIELD

The present embodiment discussed herein is related to a metadata management program and an information processing apparatus.

### BACKGROUND

Currently, a High-Performance Computing (HPC) system that is a computer system for performing large-scale calculation generally has a configuration that performs calculation at high speed by using a large number of computers that are referred to as nodes and have the same configuration. In this type of HPC system, the size of the used file becomes enormous, and a high-performance processing capacity is required.

In a normal file system, information associated with a file such as a file name, a directory name, permission of the file and information regarding content of the file are stored in the same hardware. In the following, the information associated with the file is referred to as metadata, and the information regarding the content of the file is referred to as file data.

In a case of this type of file system, in the field of the HPC system, a configuration referred to as a distributed file system is adopted that separates metadata and file data and stores the respective pieces of data in different computers.

This distributed file system includes, for example, a storage device (Object Storage Target (OST)) that stores file data, a server (Object Storage Server (OSS)) that controls the OST, a storage device (Metadata Target (MDT)) that manages metadata, and a server (Metadata Server (MDS)) that controls the MDT. Furthermore, a plurality of compute nodes using the distributed file system is connected to the distributed file system via the network.

In a large-scale H PC system, the number of simultaneous accesses to the file system is also enormous. To cope with such a large amount of file accesses, the plurality of OSTs, the plurality of OSSs, the plurality of MDTs, and the plurality of MDSs are often disposed.

Note that, as related art of the distributed file system, there is related art that collects and processes requests as one request in a case where metadata is cached on a memory and a request for metadata equal to or more than a threshold is received (for example, Japanese Laid-open Patent Publication No. 2017-123040). Furthermore, there is related art that manages an access to a file with a hash value and manages whether or not the file is deleted using a deletion flag (for example, Japanese Laid-open Patent Publication No. 2013-73557). Moreover, there is related art that manages metadata using a file directory structure and a hash value including association with a file (Japanese National Publication of International Patent Application No. 2002-501255).

### SUMMARY

According to an aspect of the embodiments, a non-transitory computer-readable storage medium having stored a metadata management program that controls a distributed file system of metadata of a directory and a file and causes a computer to execute a process including: managing metadata of a first directory by a first metadata management device; and copying the metadata of the first directory from the first metadata management device to a second metadata management device in a case where the second metadata management device creates and manages metadata of a second directory or a first file under the first directory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a distributed file system;

FIG. 2 is a block diagram of an MDS;

FIG. 3 is a diagram of an example of a metadata management table;

FIG. 4 is a diagram illustrating a state where a first directory is created;

FIG. 5 is a diagram illustrating a state where a first file is created;

FIG. 6 is a diagram illustrating an inquiry state of metadata of a parent directory at the time when a second file is created;

FIG. 7 is a diagram illustrating a response state in response to the inquiry of the metadata of the parent directory at the time when the second file is created;

FIG. 8 is a diagram illustrating a state when metadata of the parent directory is copied at the time when the second file is created;

FIG. 9 is a diagram illustrating a state at the time when the second file is created;

FIG. 10 is a diagram illustrating a state at the time when a directory under which a file exists is deleted;

FIG. 11 is a diagram illustrating a state at the time when an MDS in charge of the parent directory deletes a file;

FIG. 12 is a diagram illustrating a state of parent directory update processing at the time of the deletion by the MDS in charge of the parent directory;

FIG. 13 is a diagram illustrating a state when an MDS other than the MDS in charge of the parent directory deletes a file;

FIG. 14 is a diagram illustrating a state when the MDS in charge of the parent directory updates a bitmap of the parent directory;

FIG. 15 is a diagram illustrating a state when an empty directory is deleted;

FIG. 16 is a flowchart of file or directory creation processing;

FIG. 17 is a flowchart of file deletion processing;

FIG. 18 is a flowchart of directory deletion processing; and

FIG. 19 is a hardware configuration diagram of an MDS.

### DESCRIPTION OF EMBODIMENTS

In a file system including a plurality of MDSs, access performance to specific metadata is scaled out. However, with the configuration including the plurality of MDSs, performance of processing may be deteriorated in comparison with a case of a configuration having a single MDS. For example, some distributed file systems include the plurality of MDSs to handle a large number of accesses and copy metadata of a directory that has been newly created when a directory is created between the MDSs in order to maintain consistency between the MDSs. In this case, when the number of MDSs increases, a time period to perform copying at the time when the directory is created becomes a non-negligible amount, and there is a possibility that the performance is largely deteriorated. Furthermore, at the time when the directory is deleted, conversely, metadata of all the MDSs in which the metadata of the deleted directory exists is deleted. Therefore, there is a possibility that the performance is deteriorated due to an increase in the number of MDSs.

As a method of solving the performance deterioration, there is a technology that calculates a hash using a full path to a file without synchronizing the plurality of MDSs, stores metadata in the only one MDS that is determined from the calculated hash value, and does not perform copying. With this technology, because the copy of the metadata does not exist, it is possible to avoid the deterioration in the performance at the time when the directory is created and the deletion performance. However, with this technology, an access to the metadata of the parent directory occurs to check an authority or to update the metadata each time when the file is created or deleted. Because the metadata of the parent directory is stored in the single MDS, accesses are concentrated on the MDS that manages the metadata of the parent directory, and there is a possibility that the performance is deteriorated.

The disclosed technology has been made in view of the above, and an object is to provide a metadata management program and an information processing apparatus that improve processing performance of a distributed file system.

Hereinafter, embodiments of a metadata management program and an information processing apparatus disclosed in the present application will be described in detail with reference to the drawings. Note that the following embodiments do not limit the metadata management program and the information processing apparatus disclosed in the present application.

### Embodiments

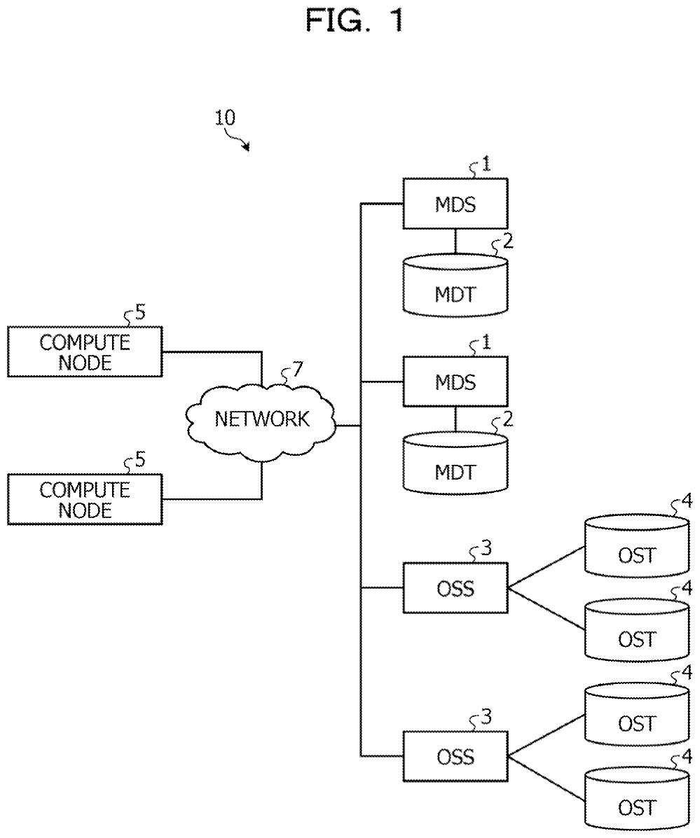

FIG. 1 is a block diagram of a distributed file system. A distributed file system 10 includes a plurality of MDSs 1, MDTs 2 connected to the respective MDSs 1, a plurality of OSSs 3, OSTs 4 connected to one of OSSs 3, a plurality of compute nodes 5, and a network 7. The MDS 1, the OSS 3, and the plurality of compute nodes 5 are connected to each other via the network 7. The distributed file system 10 is, for example, Lustre (registered trademark). Each device includes, for example, an interface compliant to the standard of the Portable Operating System Interface (POSIX).

The OST 4 is a storage device that stores file data. The single or the plurality of OSTs 4 is connected to one of the plurality of OSSs 3.

The plurality of OSSs 3 is disposed in the distributed file system 10. The OSS 3 is a server that controls the OST 4 connected to its own device. Specifically, for example, the OSS 3 receives a command to read or write file data from or to the compute node 5 and follows the command to read or write the file data from or to the OST 4 connected to its own device.

The MDT 2 is a storage device that stores metadata corresponding to the file data stored in the OST 4. The metadata includes, for example, a size, a creation time, a storage location, or the like of the corresponding file data. The single or the plurality of MDTs 2 is connected to each respective MDS 1.

The plurality of MDSs 1 is disposed in the distributed file system 10. The MDS 1 is a server that controls the MDT 2 connected to its own device. The MDS 1 manages the metadata stored in the MDT 2.

Furthermore, the MDS 1 receives a request transmitted from the compute node 5 via the network 7. Then, the MDS 1 creates or deletes a directory or a file in response to the received request. The MDS 1 and the MDT 2 connected to and managed by the MDS 1 configures an example of an “information processing apparatus”.

The compute node 5 performs calculation using the file data stored in the OST 4. Then, the compute node 5 transmits a command to the OSS 3 via the network 7 and reads and writes file data specified by the command. Furthermore, the compute node 5 instructs, for example, the distributed file system 10 to execute various types of processing. For example, the compute node 5 instructs the MDS 1 to create or delete a directory or a file and to execute various types of processing.

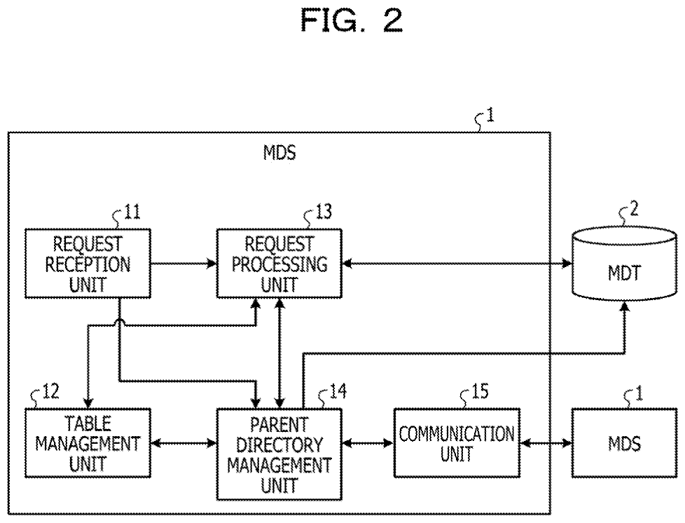

Next, management of metadata by the MDS 1 will be described in detail with reference to FIG. 2. FIG. 2 is a block diagram of the MDS. As illustrated in FIG. 2, the MDS 1 includes a request reception unit 11, a table management unit 12, a request processing unit 13, a parent directory management unit 14, and a communication unit 15.

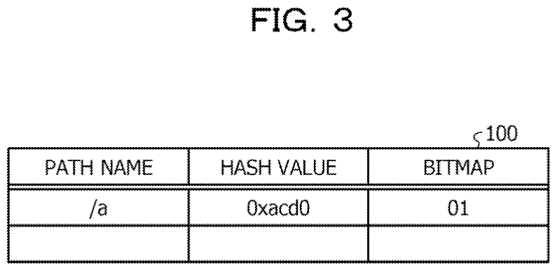

The table management unit 12 holds a metadata management table 100 illustrated in FIG. 3. FIG. 3 is a diagram of an example of a metadata management table. The metadata management table 100 is a table that, in a case of receiving a command to delete metadata of a file or a directory, determines whether or not to delete the metadata of the file or the directory.

As illustrated in FIG. 3, the metadata management table 100 includes a path name indicating a full path of a target directory or file, a hash value of the directory or the file, and a bitmap corresponding to the directory. The bitmap is given to a specific directory in the metadata management table 100 managed by an MDS in charge of the specific directory. On the other hand, in a case of a metadata management table 100 of the MDS 1 other than the MDS in charge of the specific directory, a bitmap is not given to the specific directory or file. The bitmap indicates whether or not a file or a directory exists under the directory. Here, in the present embodiment, the bitmap includes two bits. However, the number of bits corresponds to the number of MDSs 1. Then, each bit indicates information regarding each MDS 1.

The table management unit 12 executes following processing in a case where a file or a directory is created. In a case where its own device, as an MDS in charge, creates the file or the directory, the table management unit 12 receives an instruction to add information regarding the file or the directory to be created from the request processing unit 13. Then, the table management unit 12 creates an entry of the specified file or directory in the metadata management table 100 and registers a full path thereof. Next, the table management unit 12 calculates a hash value from the full path and registers the calculated value in the metadata management table 100. Moreover, the table management unit 12 creates a bitmap when the creation target is a directory, and initializes all values to zero because no file and no directory exist under the directory at the time of creation. On the other hand, in a case where the creation target is a file, the table management unit 12 does not create a bitmap.

Moreover, when metadata of a parent directory to be created does not exist in the MDT 2 that is managed by the table management unit 12, the table management unit 12 receives an instruction to create an entry of the parent directory from the parent directory management unit 14. Then, the table management unit 12 registers the entry of the parent directory in the metadata management table 100. In this case, since its own device is not the MDS in charge of the parent directory, the table management unit 12 does not register the bitmap.

Furthermore, in a case where a file or a directory is created and in a case where the MDS 1 that has created the file or the directory is not the MDS in charge of the parent directory, the table management unit 12 of the MDS in charge of the parent directory executes the following processing. The table management unit 12 receives information regarding the inquiry-source MDS 1 that has created the file or the directory and an instruction to update the bitmap of the parent directory from the parent directory management unit 14. Then, the table management unit 12 changes a value of a bit corresponding to the inquiry-source MDS 1 that has created the file or the directory in the bitmap of the specified parent directory to one. This indicates that another MDS 1 includes the file or the directory disposed under the directory.

Furthermore, in a case where a file or a directory is deleted, the table management unit 12 receives an instruction to delete an entry of the deleted file or directory from the request processing unit 13. Then, the table management unit 12 deletes the entry of the specified file or directory from the metadata management table 100.

Furthermore, in a case where a file or a directory is deleted and in a case where the MDS 1 that has created the file or the directory is not the MDS in charge of the parent directory, the table management unit 12 of the MDS 1 that has performed the creation executes the following processing. In a case where the file or the directory is deleted and the file and the directory managed by its own device do not exist under the parent directory, the table management unit 12 receives an instruction to delete an entry of the parent directory from the parent directory management unit 14. Then, the table management unit 12 deletes an entry of the specified parent directory from the metadata management table 100.

Furthermore, in a case where a file or a directory is deleted, and in a case where its own device is the MDS in charge of the parent directory and no directory and no file exist under the parent directory, the table management unit 12 executes the following processing. The table management unit 12 receives a notification indicating that the parent directory is an empty directory from the parent directory management unit 14. Then, the table management unit 12 updates a value corresponding to its own device in the bitmap of the parent directory to zero. As a result, the bitmap of the parent directory indicates that the file or the directory under the parent directory does not exist in the MDT 2 managed by its own device. However, even if all the values of the bitmap are set to zero, the metadata of the directory managed by the MDS in charge is not deleted until a directory deletion command is input.

Furthermore, in a case where a file or a directory is deleted and the MDS 1 that has deleted the file or the directory is not the MDS in charge of the parent directory, the table management unit 12 of the MDS in charge of the parent directory executes the following processing. The table management unit 12 receives information regarding the MDS 1 that has performed deletion and an input of a request to update the bitmap of the parent directory from the parent directory management unit 14. Then, the table management unit 12 changes a value of a transmission source of the update request on the bitmap of the parent directory in the metadata management table 100 to zero. As a result, the bitmap of the parent directory indicates that the transmission source of the update request does not have a file and a directory under the parent directory.

Returning to FIG. 2, the description will be continued. The request reception unit 11 receives a request to create or delete a directory or to create or delete a file, transmitted from the compute node 5. Then, the request reception unit 11 outputs the received request to the request processing unit 13.

The request processing unit 13 receives an input of the request from the request reception unit 11. In a case where the acquired request is the request to create a file or a directory, the request processing unit 13 executes the following processing. The request processing unit 13 instructs the parent directory management unit 14 to confirm whether or not the metadata of the parent directory exists.

In a case where the parent directory to be created exists, the request processing unit 13 receives a response indicating that the metadata of the parent directory exists from the parent directory management unit 14. In a case where no parent directory to be created exists, after the metadata of the parent directory acquired from the MDS in charge of the parent directory is stored in the MDT 2, the request processing unit 13 receives the response indicating that the metadata of the parent directory exists from the parent directory management unit 14. The creation of the metadata of the parent directory corresponds to copying of the metadata of the parent directory. By copying the metadata of the parent directory, the metadata up to the parent directory exists in the MDT 2 of its own device.

When receiving the response indicating that the metadata of the parent directory exists from the parent directory management unit 14, the request processing unit 13 refers to the metadata stored in the MDT 2 and confirms an access right to the parent directory. After confirming the access right to the parent directory, the request processing unit 13 creates metadata to be created in the MDT 2. Moreover, the request processing unit 13 instructs the table management unit 12 to add information regarding the file or the directory to be created.

Thereafter, the request processing unit 13 updates an update time of the directory in the metadata of the parent directory in the MDT 2. The request processing unit 13 executes processing similar to the processing at the time of file creation when creating a directory.

In a case where the acquired request is the request to delete the file, the request processing unit 13 executes the following processing. The existence of the file in the MDT 2 connected to its own device guarantees that the parent directory of the file exists in the MDT 2. Therefore, the request processing unit 13 confirms an access right to the parent directory of the file to be deleted that is stored in the MDT 2. When the access right to the parent directory can be confirmed, the request processing unit 13 deletes the file to be deleted. Then, the request processing unit 13 instructs the table management unit 12 to delete an entry of the deleted file.

Next, the request processing unit 13 instructs the parent directory management unit 14 to execute parent directory update processing at the time of deletion. Thereafter, the request processing unit 13 updates an update time of the directory in the metadata of the parent directory in the MDT 2.

In a case where the acquired request is the request to delete the directory, the request processing unit 13 executes the following processing. The request processing unit 13 refers to the metadata management table 100 held by the table management unit 12 and determines whether or not all the values of the bitmap of the directory to be deleted are zero. In a case where the bitmap has a value other than zero, the request processing unit 13 notifies the compute node 5 of an end of processing due to an error.

On the other hand, in a case where all the values of the bitmap are zero, the request processing unit 13 determines that the file and the directory do not exist under the directory to be deleted. Then, the request processing unit 13 confirms an access right to the parent directory of the directory to be deleted that is stored in the MDT 2. When the access right to the parent directory can be confirmed, the request processing unit 13 deletes metadata of the directory to be deleted in the MDT 2 and deletes the directory. Moreover, the request processing unit 13 instructs the table management unit 12 to delete an entry of the deleted directory.

Next, the request processing unit 13 instructs the parent directory management unit 14 to execute parent directory update processing at the time of deletion. Thereafter, the request processing unit 13 updates an update time of the directory in the metadata of the parent directory in the MDT 2.

The parent directory management unit 14 executes the following processing at the time of creating the directory or the file. The parent directory management unit 14 receives an instruction to confirm whether or not the metadata of the parent directory exists from the request processing unit 13. The parent directory management unit 14 refers to the metadata management table 100 held by the table management unit 12 and determines whether or not metadata up to the parent directory exists. Specifically, for example, the parent directory management unit 14 confirms whether or not the metadata up to the parent directory exists according to whether or not an entry that matches a path name to the parent directory exists in the metadata management table 100. In a case where the metadata up to the parent directory exists, the parent directory management unit 14 outputs a response indicating that the metadata of the parent directory exists to the request processing unit 13.

On the other hand, in a case where the metadata up to the parent directory does not exist, the parent directory management unit 14 identifies in which directory among directories in upper layers that store the parent directory the metadata does not exist. Then, in a case where a plurality of layers includes the directories in which the metadata does not exist, the parent directory management unit 14 calculates a hash value of a directory in the lowest layer among the directories in which the metadata does not exist. Then, the parent directory management unit 14 instructs the communication unit 15 to inquire the metadata with respect to the directory in the lowest layer among the directories in which the metadata does not exist, using the calculated hash value. Thereafter, the parent directory management unit 14 receives an input of the metadata of the parent directory from the communication unit 15. Then, the parent directory management unit 14 stores the acquired metadata in the MDT 2 and creates the metadata of the parent directory. Moreover, the parent directory management unit 14 instructs the table management unit 12 to create an entry of the parent directory.

Until the creation of the metadata of all the directories in the upper layers for storing the parent directory to be created is completed, the parent directory management unit 14 sequentially repeats an inquiry of the metadata for each layer. When the creation of the metadata of all the directories in the upper layers that store the parent directory to be created is completed, the parent directory management unit 14 outputs a response indicating that the metadata of the parent directory exists to the request processing unit 13.

On the other hand, in a case where a file or a directory is created, the parent directory management unit 14 of the MDS 1 that is other than the MDS in charge and that is the MDS in charge of the parent directory to be created receives an inquiry of the metadata of the parent directory from the communication unit 15. Then, the parent directory management unit 14 determines whether or not the metadata of the parent directory exists in the MDT 2 managed by its own device.

In a case where the metadata of the parent directory does not exist, the parent directory management unit 14 instructs the communication unit 15 to transmit a notification indicating an end of processing due to an error to the MDS 1 that is an inquiry transmission source. On the other hand, in a case where the metadata of the parent directory exists, the parent directory management unit 14 acquires the metadata of the parent directory from the MDT 2 managed by its own device. Then, the parent directory management unit 14 instructs the communication unit 15 to transmit the acquired metadata of the parent directory to the MDS 1 that is the inquiry transmission source. The parent directory management unit 14 instructs the table management unit 12 to update information regarding the MDS 1 that is the inquiry source that has created the file or the directory and the bitmap of the parent directory.

The parent directory management unit 14 executes the following processing at the time of deleting the directory or the file. The parent directory management unit 14 receives the instruction of the parent directory update processing at the time of deletion from the request processing unit 13.

Then, the parent directory management unit 14 refers to the metadata management table 100 held by the table management unit 12 and determines whether or not the file or the directory under the parent directory exists in the MDT 2 that is managed. For example, the parent directory management unit 14 makes this determination according to whether or not another entry having a full path which forward-matches a full path to one layer higher than a full path to be deleted exists in the metadata management table 100.

In a case where the file or the directory under the parent directory exists in the MDT 2 that is managed, the parent directory management unit 14 determines to maintain the information regarding the parent directory. In other words, for example, in a case where one file or directory under the parent directory exists, the parent directory management unit 14 maintains a value of the bitmap corresponding to its own device even if its own device is the MDS in charge. Furthermore, even if its own device is not the MDS in charge, in a case where one file or directory under the parent directory exists, the parent directory management unit 14 continuously holds the metadata of the parent directory.

On the other hand, in a case where the file or the directory under the parent directory does not exist in the MDT 2 that is managed, the parent directory management unit 14 acquires a hash value of the parent directory from the metadata management table 100. Then, the parent directory management unit 14 determines whether or not its own device is the MDS in charge of the parent directory using the acquired hash value.

In a case where its own device is the MDS in charge, the parent directory management unit 14 issues a notification indicating that the parent directory of its own device in the metadata management table 100 is an empty directory to the table management unit 12.

On the other hand, in a case where its own device is not the MDS in charge, the parent directory management unit 14 deletes metadata of the parent directory from the MDT 2 that is managed. Furthermore, the parent directory management unit 14 acquires the hash value of the parent directory from the metadata management table 100. Moreover, the parent directory management unit 14 instructs the table management unit 12 to delete an entry of the parent directory.

Next, the parent directory management unit 14 identifies the MDS in charge of the parent directory from the acquired hash value. Then, the parent directory management unit 14 instructs the communication unit 15 to notify the MDS in charge of the parent directory of a bitmap update request. Thereafter, the parent directory management unit 14 receives a notification indicating that the update of the bitmap of the parent directory has been completed from the communication unit 15. Then, the parent directory management unit 14 executes the parent directory update processing at the time of deletion on the deleted parent directory. The parent directory management unit 14 recursively executes the parent directory update processing at the time of deletion on the parent directory of the deleted directory until its own device serves as the MDS in charge or the parent directory no longer exists.

For example, a case will be described where pieces of metadata such as “/a”, “/a/b”, and “/a/b/c” exist in the MDT 2 managed by the MDS in charge of the file to be deleted. In this case, when “/a/b/c” is the file to be deleted and the file is deleted, the MDS 1 executes processing on the “/a/b” at the first time of the parent directory update processing at the time of deletion. Then, in a case where the MDS in charge of “/a/b” is a different MDS 1, metadata of “/a/b” is deleted from the MDT 2 managed by the MDS in charge of the file to be deleted. At this time, no file and no directory under “/a” exist, and the MDS 1 that is the MDS in charge of the file to be deleted executes the parent directory update processing at the time of deletion one more time.

In a case where the file or the directory is deleted, the parent directory management unit 14 of the MDS 1 that is the MDS in charge of the parent directory to be deleted other than the MDS in charge of the file or the directory to be deleted receives an input of a request to update a bitmap of the parent directory from the communication unit 15 of its own device. Then, the parent directory management unit 14 of the MDS in charge of the parent directory outputs information regarding the MDS in charge of the file or the directory to be deleted and the request to update the bitmap of the parent directory to the table management unit 12 of its own device. Thereafter, the parent directory management unit 14 of the MDS in charge of the parent directory instructs the communication unit 15 of its own device to notify that the update of the bitmap of the parent directory is completed.

In a case of creating a file or a directory, the communication unit 15 of the MDS in charge of the file or the directory to be created receives an instruction to inquire metadata to a directory in the lowest layer among the directories in which metadata does not exist from the parent directory management unit 14. Then, the communication unit 15 of the MDS in charge of the file or the directory to be created inquires of the MDS in charge indicated by a hash value of a directory to be an inquiry target of the metadata about metadata of the specified directory.

Thereafter, the communication unit 15 of the MDS in charge of the file or the directory to be created receives, as a response to the inquiry, an error response or the metadata of the parent directory from the MDS 1 that is the MDS in charge of the parent directory and is an inquiry destination. Then, in response to the inquiry, the communication unit 15 of the MDS in charge of the file or the directory to be created outputs the error response or the metadata of the parent directory to the parent directory management unit 14 of its own device.

On the other hand, the communication unit 15 of the MDS 1 to be an inquiry target about the metadata of the parent directory receives the inquiry of the metadata of the parent directory from the MDS 1 that creates the file or the directory. In other words, for example, the communication unit 15 of the MDS in charge of the parent directory receives the inquiry of the metadata of the parent directory from the MDS in charge of the file or the directory to be created. Then, the communication unit 15 of the MDS in charge of the parent directory outputs the acquired inquiry of the metadata of the parent directory to the parent directory management unit 14 of its own device. Thereafter, the communication unit 15 of the MDS in charge of the parent directory receives, as a response to the inquiry, an error response or an input of the metadata of the parent directory from the parent directory management unit 14 of its own device. Then, the communication unit 15 of the MDS in charge of the parent directory transmits the acquired response to the inquiry to the MDS in charge of the file or the directory to be created that is the inquiry source.

In a case where a file or a directory is deleted, the communication unit 15 of the MDS in charge of the file or the directory to be deleted instructs the parent directory management unit 14 of its own device to notify a bitmap update request. Then, the communication unit 15 of the MDS in charge of the file or the directory to be deleted transmits the bitmap update request to the MDS in charge of the parent directory to be deleted. Thereafter, the communication unit 15 of the MDS in charge of the file or the directory to be deleted receives a notification indicating that the update of the bitmap of the parent directory is completed from the MDS in charge of the parent directory. Then, the communication unit 15 of the MDS in charge of the file or the directory to be deleted outputs the received notification indicating that the update of the bitmap of the parent directory is completed to the parent directory management unit 14 of the own device.

On the other hand, when the file or the directory is deleted, the communication unit 15 of the MDS in charge of the parent directory to be deleted receives a notification of a bitmap update request from the MDS in charge of the file or the directory to be deleted that has performed deletion. Thereafter, the communication unit 15 of the MDS in charge of the parent directory receives the notification indicating that the bitmap update is completed from the parent directory management unit 14 of its own device. Then, the communication unit 15 of the MDS in charge of the parent directory transmits the notification indicating that the bitmap update is completed to the MDS in charge of the file or the directory to be deleted.

In the above description, the MDS 1 that has created the file or the directory is an example of a “second metadata management device”. Then, the MDS in charge of the parent directory in a case where the MDS 1 that has created the file or the directory is not the MDS in charge of the parent directory to be created is an example of a “first metadata management device”. Furthermore, the parent directory managed by the MDS in charge of the parent directory in a case where the MDS 1 that has created the file or the directory is not the MDS in charge of the parent directory to be created is an example of a “first directory”. Furthermore, the directory to be created in a case where the MDS 1 that has created the file or the directory is not the MDS in charge of the parent directory to be created is an example of a “second directory”, and a file to be created is an example of a “first file”.

Next, an example of file creation processing will be described. In the following, a full path represents a directory or a file. In other words, for example, “/a” represents a directory or a file having “a” in a full path.

Here, a case will be described where an MDS #0 and an MDS #1 exist as the MDSs 1, an MDT 2 managed by the MDS #0 is an MDT ##0, and an MDT 2 managed by the MDS #1 is an MDT ##1. Here, an MDS in charge of a file or a directory of which the last one digit of a hash value is zero is the MDS #0, and an MDS in charge of a file or a directory of which the last one digit of a hash value is one is the MDS #1.

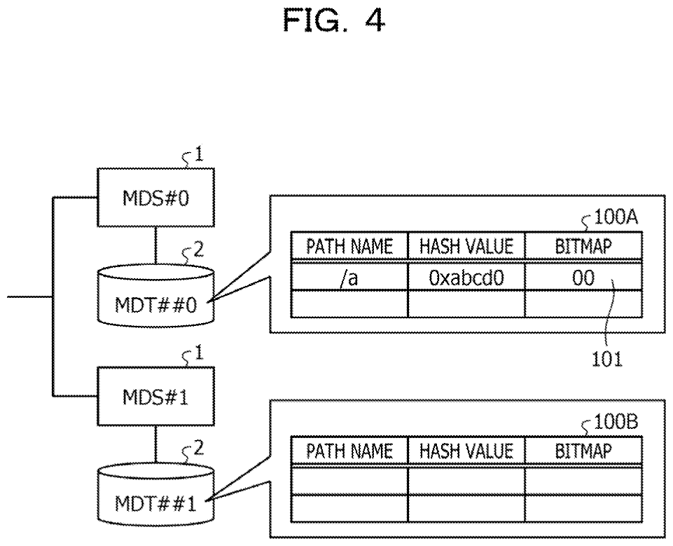

FIG. 4 is a diagram illustrating a state where the first directory is created. First, “/a” that is a directory is created. Here, a hash value of “/a” is set to “0xabcd0”. In other words, for example, the MDS #0 is an MDS in charge of “/a”. Then, a request reception unit 11 of the MDS #0 receives a request to create “/a”. Since a parent directory does not exist in “/a”, a request processing unit 13 creates “/a”. Then, a table management unit 12 adds an entry 101 of “/a” in a metadata management table 100A that indicates metadata managed by the MDS #0 as illustrated in FIG. 4. Moreover, the table management unit 12 registers “0xabcd0” to a hash value of the entry 101. Moreover, since “/a” is the directory, the table management unit 12 registers a bitmap in the entry 101 and initializes all values to zero.

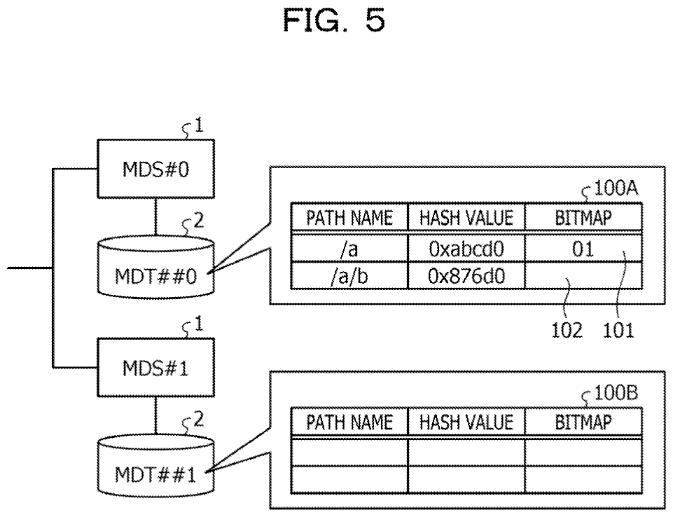

FIG. 5 is a diagram illustrating a state where the first file is created. Next, a file “/a/b” is created. Here, a hash value of “/a/b” is set to “0x876d0”. In other words, for example, the MDS #0 is an MDS in charge of “/a/b”. Therefore, the request reception unit 11 of the MDS #0 receives a request to create “/a/b”. The request processing unit 13 instructs a parent directory management unit 14 to confirm whether or not the parent directory “/a” of “/a/b” exists. Since “/a” is registered in the entry 101 of the metadata management table 100A, the parent directory management unit 14 outputs a response indicating that the metadata of the parent directory exists to the request processing unit 13. The request processing unit 13 creates “/a/b” in response to an input of the response indicating that the metadata of the parent directory exists. Then, the table management unit 12 adds the entry 101 of “/a/b” to the metadata management table 100A as illustrated in FIG. 5. Moreover, the table management unit 12 registers “0x876d0” to a hash value of the entry 101. Here, because “/a/b” is a file, the table management unit 12 does not register a bitmap in an entry 102.

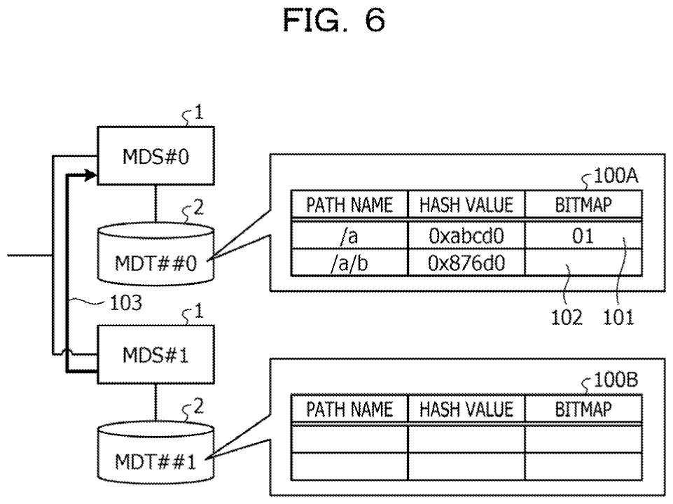

FIG. 6 is a diagram illustrating an inquiry state of metadata of a parent directory at the time when the second file is created. Next, a file “/a/c” is created. Here, a hash value of “/a/c” is set to “0x876d1”. In other words, for example, the MDS #1 is an MDS in charge of “/a/c”. Therefore, the request reception unit 11 of the MDS #1 receives a request to create “/a/c”. The request processing unit 13 instructs a parent directory management unit 14 to confirm whether or not the parent directory “/a” of “/a/c” exists. Because an entry of “/a” does not exist in a metadata management table 100B indicating metadata managed by the MDS #1, the parent directory management unit 14 determines that metadata of “/a” does not exist in the MDT ##1. Then, the parent directory management unit 14 performs an inquiry 103 about the metadata of “/a” as illustrated in FIG. 6.

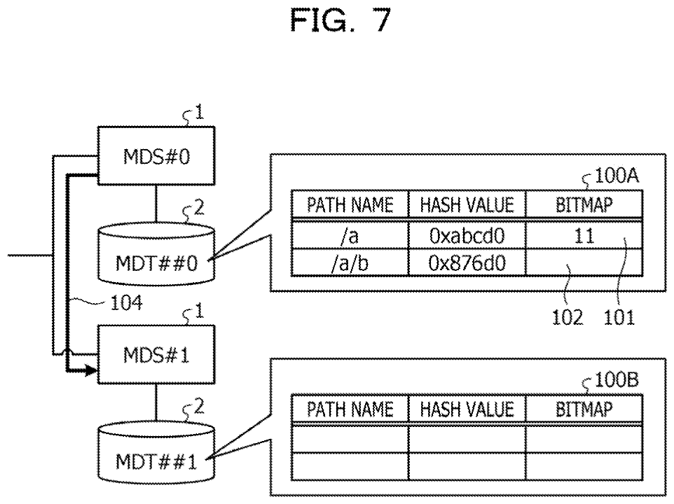

FIG. 7 is a diagram illustrating a response state in response to the inquiry of the metadata of the parent directory at the time when the second file is created. When receiving the inquiry 103 about the metadata of “/a” from the MDS #1, the parent directory management unit 14 of the MDS #0 refers to the metadata management table 100A and confirms that the metadata of “/a” exists. Then, the parent directory management unit 14 acquires the metadata of “/a” from the MDT ##0. Thereafter, the parent directory management unit 14 transmits the metadata of “/a” to the MDS #1 as a response 104 as illustrated in FIG. 7. Furthermore, the parent directory management unit 14 instructs the table management unit 12 to update information regarding the inquiry-source MDS #1 that has created “/a/c” and a bitmap of “/a”. The table management unit 12 changes a value of a bit corresponding to the inquiry-source MDS #1 that has created “/a/c” in the bitmap of “/a” to one.

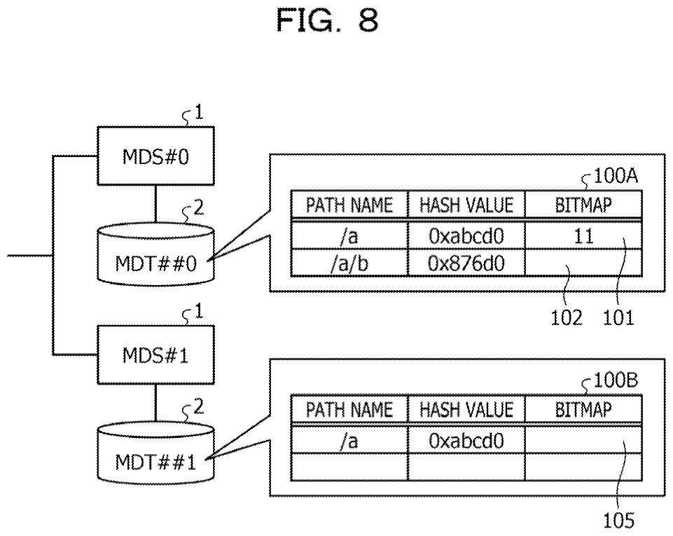

FIG. 8 is a diagram illustrating a state when metadata of the parent directory is copied at the time when the second file is created. The parent directory management unit 14 of the MDS #1 receives the response 104 including the metadata of “/a”. Then, the parent directory management unit 14 stores the acquired metadata of “/a” in the MDT ##1. The table management unit 12 adds an entry 105 of “/a” in the metadata management table 100B as illustrated in FIG. 8. Moreover, the table management unit 12 registers “0xabcd0” to a hash value of an entry 106. Here, since the MDS in charge of “/a” is not its own device, the table management unit 12 does not register a bitmap in the entry 105. Thereafter, the parent directory management unit 14 outputs a response indicating that metadata of a parent directory of “/a/c” exists to the request processing unit 13.

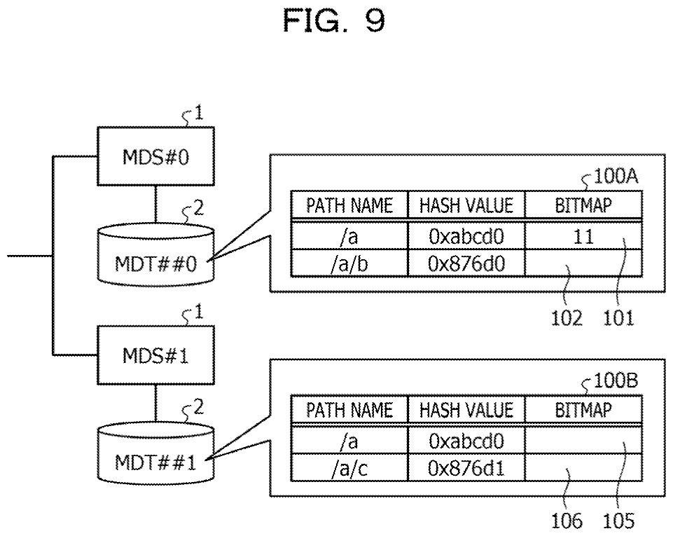

FIG. 9 is a diagram illustrating a state at the time when the second file is created. The request processing unit 13 of the MDS #1 receives an input of the response indicating that the metadata of the parent directory of “/a/c” exists from the parent directory management unit 14. Then, the request processing unit 13 creates “/a/c” in the MDT ##1. Thereafter, the request processing unit 13 instructs the table management unit 12 to add an entry of “/a/c”. The table management unit 12 adds the entry 106 of “/a/c” to the metadata management table 100B. Moreover, the table management unit 12 registers “0x876d1” to a hash value of the entry 106. Here, because “/a/c” is a file, the table management unit 12 does not register a bitmap in the entry 106.

Next, an example of processing for deleting a directory and a file will be described. Here, a case where a directory and a file are deleted from the state illustrated in FIG. 9 will be described.

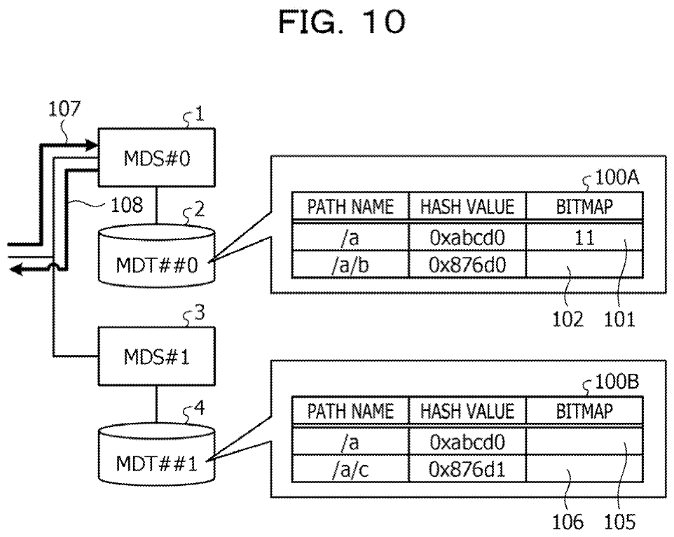

FIG. 10 is a diagram illustrating a state at the time when a directory under which a file exists is deleted. Here, deletion of a directory “/a” is instructed. The request reception unit 11 of the MDS #0 that is an MDS in charge of “/a” receives a request 107 to delete “/a”. The request reception unit 11 refers to a bitmap of “/a” in the metadata management table 100A. In this case, because the bitmap of “/a” includes a bit having a value of one, the request reception unit 11 determines that a directory or a file disposed under “/a” in any one of the MDSs 1 exists and “/a” is not empty. Therefore, the request reception unit 11 notifies a transmission source of the request of an error indicating that “/a” is not empty as a response 108.

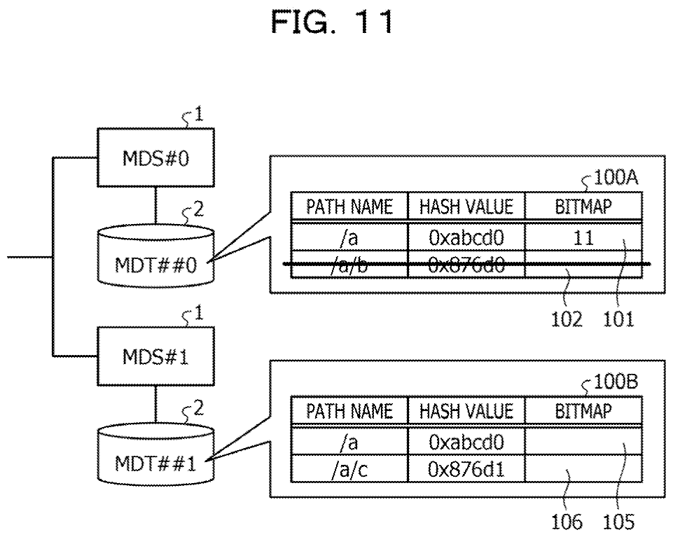

FIG. 11 is a diagram illustrating a state at the time when an MDS in charge of the parent directory deletes a file. Here, deletion of “/a/b” is instructed. The request reception unit 11 of the MDS #0 that is an MDS in charge of “/a/b” receives a request to delete “/a/b”. The request processing unit 13 confirms an access right to “/a” that is the parent directory of “/a/b” stored in the MDT ##0. When the access right to the parent directory can be confirmed, the request processing unit 13 deletes “/a/b”. The table management unit 12 deletes the entry 102 of “/a/b” from the metadata management table 100A. Here, a strike-through line is added to the deleted entry 102 for easy understanding. The entry 102 to which the strike-through line is added does not actually exist in the metadata management table 100A.

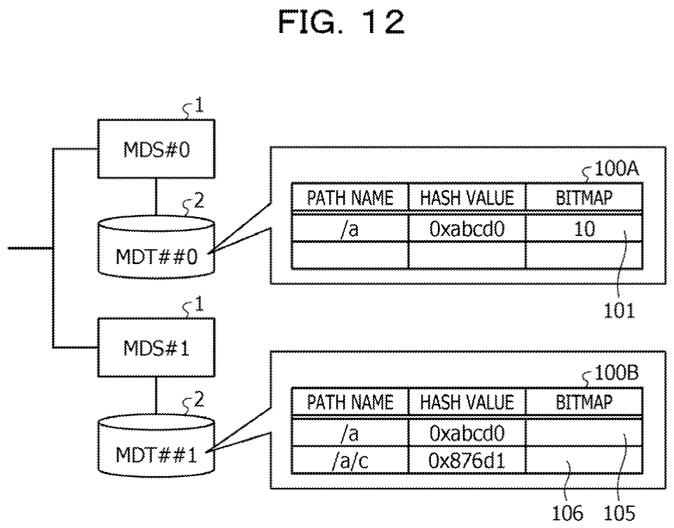

FIG. 12 is a diagram illustrating a state of parent directory update processing at the time of the deletion by the MDS in charge of the parent directory. In the state in FIG. 11, the request processing unit 13 instructs the parent directory management unit 14 to execute parent directory update processing at the time of deletion. Because the MDS in charge of “/a” that is the parent directory of “/a/b” is the MDS #0, the parent directory management unit 14 sets a bit corresponding to its own device in the bitmap of the entry 101 of “/a” in the metadata management table 100B to zero. Here, the parent directory management unit 14 changes “11” to “10”.

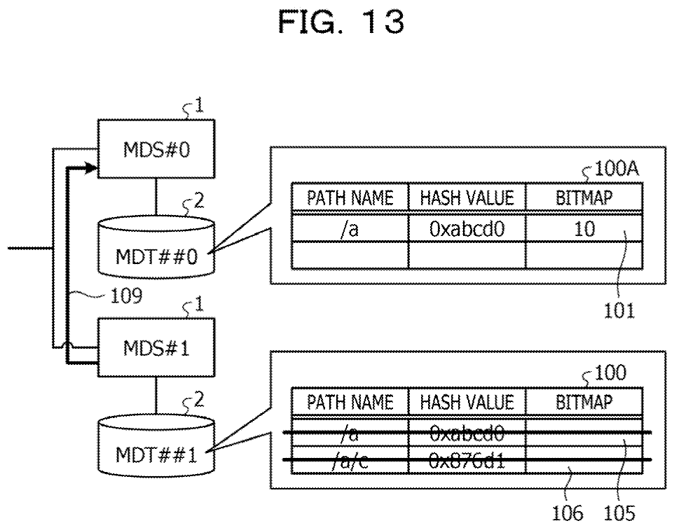

FIG. 13 is a diagram illustrating a state when an MDS other than the MDS in charge of the parent directory deletes a file. Here, deletion of “/a/c” is instructed in the state in FIG. 12. The request reception unit 11 of the MDS #1 that is the MDS in charge of “/a/c” receives a request to delete “/a/c”. The request processing unit 13 confirms an access right to “M” that is the parent directory of “/a/c” stored in the MDT ##0. When the access right to the parent directory can be confirmed, the request processing unit 13 deletes “/a/c”. The table management unit 12 deletes the entry 106 of “/a/c” from the metadata management table 100. The parent directory management unit 14 executes the parent directory update processing at the time of deletion. In this case, since a file or a directory under “/a” does not exist in the MDT ##1 and its own device is not the MDS in charge of “/a”, the parent directory management unit 14 deletes “/a”. The table management unit 12 deletes the entry 105 of “/a” from the metadata management table 100B. In this case, for easy understanding, strike-through lines are added to the deleted entries 105 and 106.

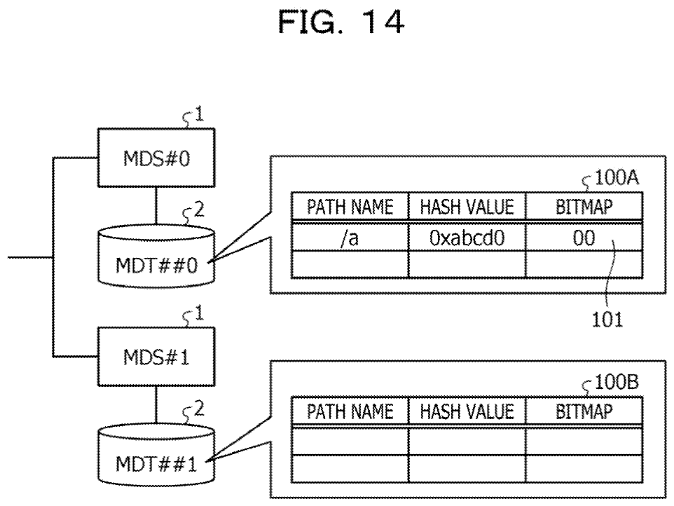

FIG. 14 is a diagram illustrating a state when the MDS in charge of the parent directory updates a bitmap of the parent directory. In the state in FIG. 13, the parent directory management unit 14 of the MDS #0 that is the MDS in charge of “/a” receives a notification to update the bitmap of the parent directory. Then, the parent directory management unit 14 notifies the table management unit 12 of the deletion of the parent directory of the MDS #1. The table management unit 12 changes a value corresponding to the MDS #1 in the bitmap of the entry 101 of “/a” in the metadata management table 100A to “zero”. In other words, for example, the table management unit 12 changes the entry 101 from “01” to “00”. In this way, even in a case where the responsible directory becomes an empty directory, the MDS in charge does not delete the directory at that point.

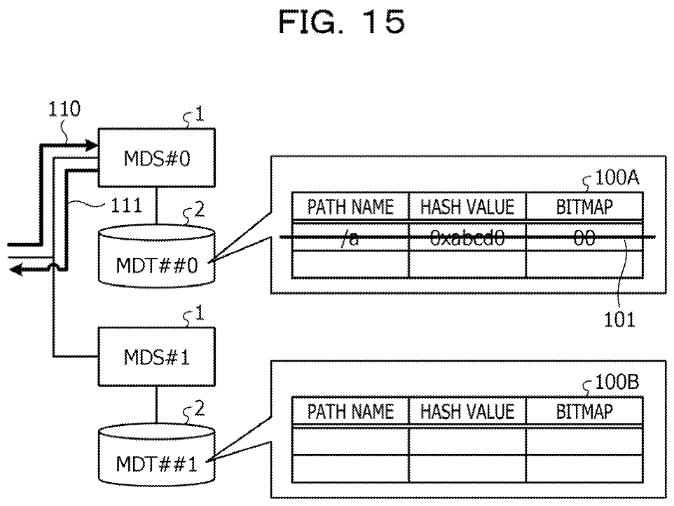

FIG. 15 is a diagram illustrating a state when an empty directory is deleted. Here, deletion of “/a” is instructed in the state in FIG. 14. The request reception unit 11 of the MDS #0 that is an MDS in charge of “/a” receives a request 110 to delete “/a”. The request processing unit 13 refers to the bitmap of the entry 101 of “/a” in the metadata management table 100A and confirms that “/a” is an empty directory. Then, the request processing unit 13 deletes “/a” from the MDT ##0. Thereafter, the table management unit 12 deletes the entry 101 of “/a” from the metadata management table 100A. Thereafter, the request processing unit 13 transmits a response 111 indicating that the deletion is completed to the transmission source of the deletion request 110.

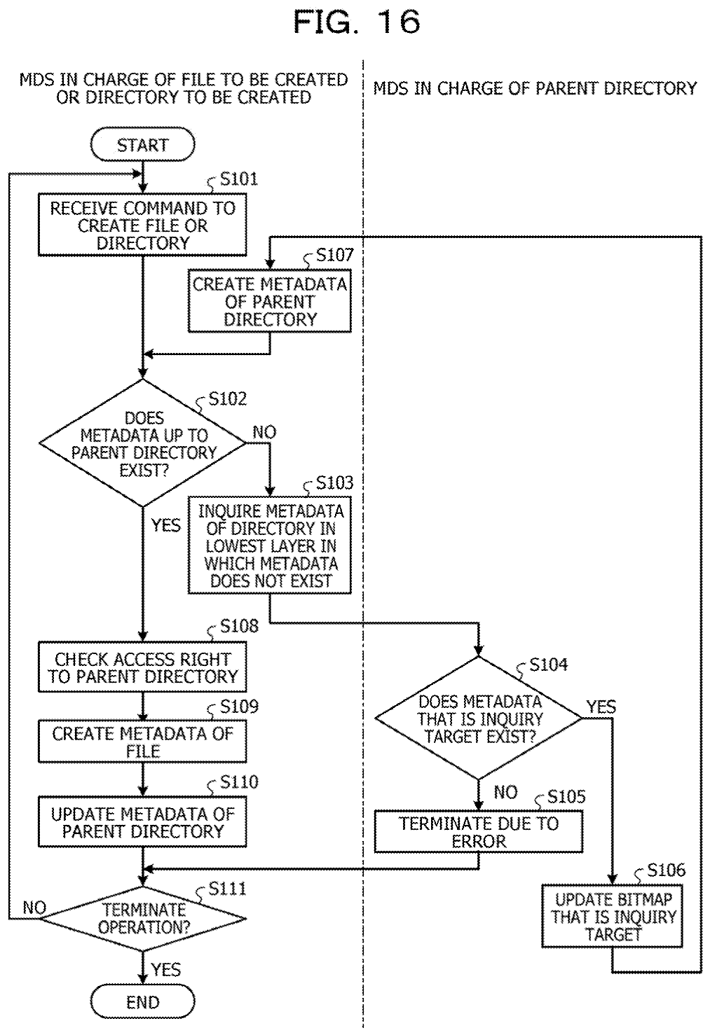

Next, a flow of processing of creating a file or a directory will be described with reference to FIG. 16. FIG. 16 is a flowchart of the processing of creating a file or a directory. In FIG. 16, the left side of a partition line illustrates processing by an MDS in charge of a file or a directory to be created, and the right side illustrates processing by an MDS in charge of a parent directory of the file to be created.

The request reception unit 11 of the MDS in charge of the file or the directory to be created receives a command to create a file or a directory (step S101). The request reception unit 11 outputs a request to create a file or a directory according to the received command to create a file or a directory to the request processing unit 13.

Next, the request processing unit 13 receives the instruction to create a file or a directory and instructs the parent directory management unit 14 to confirm whether or not metadata of the parent directory exists. The parent directory management unit 14 determines whether or not metadata exists from a directory in the top layer to the parent directory (step S102).

In a case where there is a directory in which the metadata does not exist (step S102: No), the parent directory management unit 14 instructs the communication unit 15 to inquire metadata of a directory in the lowest layer among the directories in which the metadata does not exist (step S103). The communication unit 15 inquires of the MDS in charge of the parent directory about the metadata of the specified directory.

The parent directory management unit 14 of the MDS in charge of the parent directory receives the inquiry of the metadata of the directory managed by its own device via the communication unit 15 (step S104). In a case where the metadata that is the inquiry target does not exist in the MDT 2 managed by its own device (step S104: No), the parent directory management unit 14 notifies the MDS in charge of the file to be created or the directory to be created of an error and terminates the procedure due to the error (step S105). Thereafter, the procedure proceeds to step S111. In a case where the metadata that is the inquiry target exists in the MDT 2 managed by its own device (step S104: Yes), the parent directory management unit 14 notifies the table management unit 12 of creation of a file or a directory under the directory that is the inquiry target by the MDS in charge of the file to be created or the directory to be created. Upon receiving the notification, the table management unit 12 identifies an entry of the directory that is the inquiry target in the metadata management table 100. Then, the table management unit 12 changes a value corresponding to the MDS in charge of the file to be created or the directory to be created in the bitmap of the identified entry to one and updates the bitmap (step S106). Thereafter, the parent directory management unit 14 transmits the metadata of the parent directory to the MDS in charge of the file to be created or the directory to be created.

The parent directory management unit 14 of the MDS in charge of the file to be created or the directory to be created receives an input of the metadata of the parent directory. Then, the parent directory management unit 14 stores the metadata of the parent directory in the MDT 2 managed by its own device and creates the metadata of the parent directory (step S107). The table management unit 12 creates an entry of the parent directory in the metadata management table 100. Thereafter, the procedure returns to step S102, and steps S103 to S107 are repeated until the metadata exists in all the directories up to the parent directory.

In a case where the metadata exists in all the directories up to the parent directory (step S102: Yes), the request processing unit 13 checks an access right to the parent directory using the metadata stored in the MDT 2 managed by its own device (step S108).

After confirming the access right to the parent directory, the request processing unit 13 creates metadata of the file and stores the created metadata in the MDT 2 (step S109).

Next, the request processing unit 13 updates the metadata of the parent directory (step S110).

Thereafter, the MDS in charge of the file to be created or the directory to be created determines whether or not to terminate an operation depending on whether or not a shutdown command or the like is issued (step S111). In a case where the operation is not terminated (step S111: No), the procedure returns to step S101. On the other hand, in a case where it is determined to terminate the operation (step S111: Yes), the MDS in charge of the file to be created or the directory to be created terminates the file creation processing and terminates the operation.

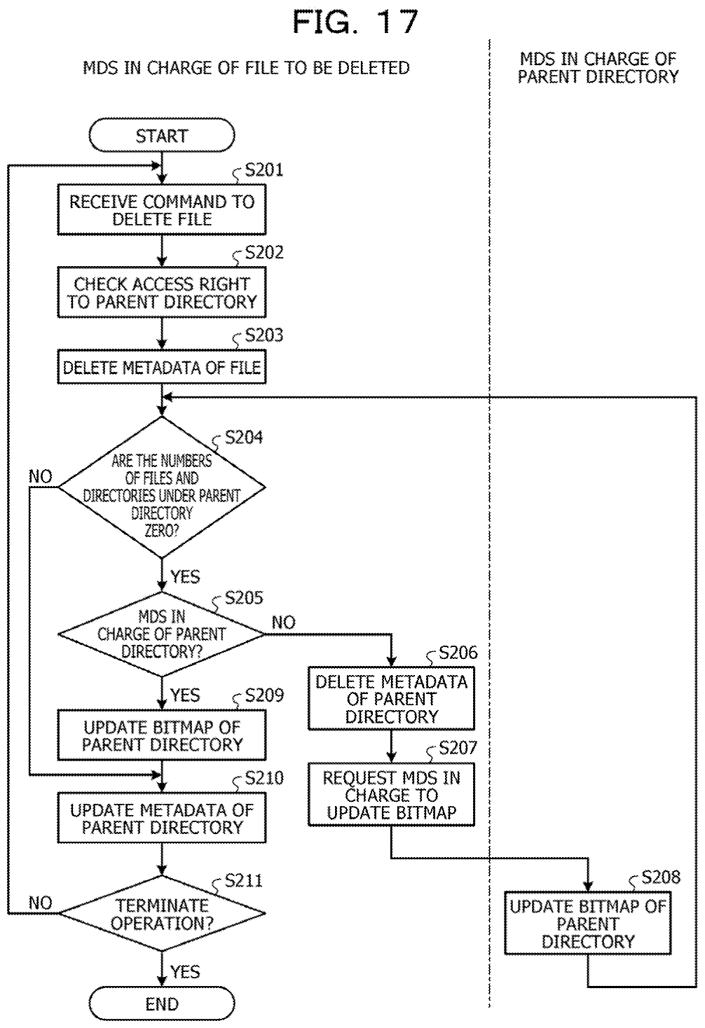

Next, a flow of file deletion processing will be described with reference to FIG. 17. FIG. 17 is a flowchart of the file deletion processing. In FIG. 17, the left side of a partition line illustrates processing by an MDS in charge of a file to be deleted, and the right side illustrates processing by an MDS in charge of a parent directory of the file to be deleted.

The request reception unit 11 receives a command to delete a file (step S201). Then, the request reception unit 11 outputs a request to delete the file to the request processing unit 13.

The request processing unit 13 checks an access right to the parent directory using metadata stored in the MDT 2 managed by its own device (step S202).

After confirming the access right, the request processing unit 13 deletes the metadata of the file to be deleted stored in the MDT 2 managed by its own device (step S203).

Thereafter, the request processing unit 13 instructs the parent directory management unit 14 to execute parent directory update processing at the time of deletion. The parent directory management unit 14 determines whether or not the numbers of files and directories under the parent directory are zero (step S204).

In a case where the number of files under the parent directory is not zero (step S204: No), the file deletion processing proceeds to step S210.

On the other hand, in a case where the number of files under the parent directory is zero, in other words, for example, the parent directory is an empty directory (step S204: Yes), the parent directory management unit 14 refers to the metadata management table 100. Then, the parent directory management unit 14 acquires a hash value of the parent directory from the metadata management table 100 and determines whether or not its own device is an MDS in charge of the parent directory (step S205).

In a case where its own device is not the MDS in charge of the parent directory (step S205: No), the parent directory management unit 14 deletes metadata of the parent directory stored in the MDT 2 managed by its own device (step S206). The parent directory management unit 14 acquires the hash value of the parent directory from the metadata management table 100. Thereafter, the table management unit 12 deletes an entry of the parent directory from the metadata management table 100.

Next, the parent directory management unit 14 identifies the MDS in charge of the parent directory from the acquired hash value. Then, the parent directory management unit 14 requests the MDS in charge of the parent directory to update a bitmap (step S207).

The parent directory management unit 14 of the MDS in charge of the parent directory receives the request to update the bitmap of the parent directory from the MDS in charge of the file to be deleted. Then, the parent directory management unit 14 outputs the request to update the bitmap of the parent directory to the table management unit 12. The table management unit 12 specifies the identified entry of the parent directory in the metadata management table 100. Thereafter, the table management unit 12 changes a value corresponding to the MDS in charge of the file to be deleted in the bitmap of the entry of the parent directory to zero (step S208). Thereafter, the file deletion processing returns to step S204. The parent directory management unit 14 of the MDS in charge of the file to be deleted recursively repeats the processing from step S204 to step S208 for the parent directory of the deleted directory. In other words, for example, the parent directory in a case where steps S204 to S208 are recursively executed is the parent directory of the directory deleted in the previous processing.

On the other hand, in a case where its own device is the MDS in charge of the parent directory (step S205: Yes), the parent directory management unit 14 notifies the table management unit 12 of that the file or the directory under the parent directory in its own device does not exist. The table management unit 12 specifies an entry of the parent directory in the metadata management table 100. Then, the table management unit 12 changes a value corresponding to its own device in the bitmap of the entry of the parent directory to zero and updates the bitmap (step S209).

Thereafter, the parent directory management unit 14 updates the metadata of the parent directory (step S210). The parent directory in steps S209 and S210 is the parent directory of the directory deleted in the previous processing in a case where the processing from step S204 to step S208 is recursively executed.

Thereafter, the MDS in charge of the file to be deleted determines whether or not to terminate the operation depending on whether or not a shutdown command or the like is issued (step S211). In a case where the operation is not terminated (step S211: No), the procedure returns to step S201. On the other hand, in a case where it is determined to terminate the operation (step S211: Yes), the MDS in charge of the file to be deleted terminates the file deletion processing and terminates the operation.

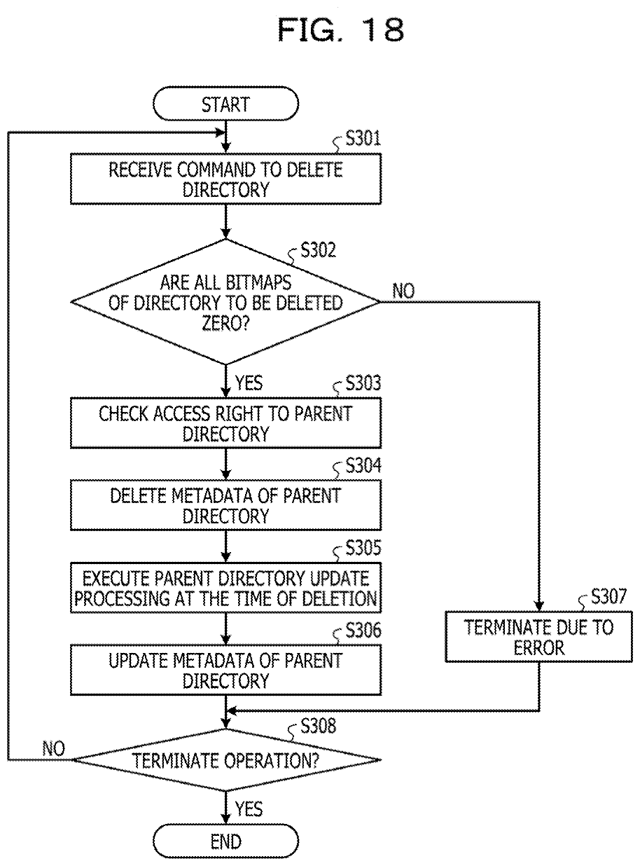

Next, a flow of directory deletion processing will be described with reference to FIG. 18. FIG. 18 is a flowchart of the directory deletion processing.

The request reception unit 11 receives a command to delete a directory (step S301). Then, the request reception unit 11 outputs a request according to the received command to the request processing unit 13.

The request processing unit 13 determines whether or not all bitmaps of a directory to be deleted in the metadata management table 100 are zero (step S302). In a case where all the bitmaps are zero (step S302: Yes), the request processing unit 13 checks an access right to the parent directory using the metadata stored in the MDT 2 managed by its own device (step S303).

After confirming the access right to the parent directory, the request processing unit 13 deletes the metadata of the parent directory from the MDT 2 managed by its own device (step S304). The table management unit 12 deletes an entry of the deleted parent directory from the metadata management table 100.

Thereafter, the request processing unit 13 transmits the update processing of the parent directory at the time of deletion to the parent directory management unit 14. The parent directory management unit 14 executes the parent directory update processing at the time of deletion (step S305). Here, the parent directory update processing at the time of deletion is processing executed in steps S204 to S209 in FIG. 17.

Thereafter, the parent directory management unit 14 updates the metadata of the parent directory (step S306).

On the other hand, in a case where a value other than zero exists in the bitmap (step S302: No), the request processing unit 13 terminates the procedure due to an error (step S307). Thereafter, the directory deletion processing proceeds to step S308.

Thereafter, the MDS in charge of the directory to be deleted determines whether or not to terminate the operation depending on whether or not a shutdown command or the like is issued (step S308). In a case where the operation is not terminated (step S308: No), the procedure returns to step S301. On the other hand, in a case where it is determined to terminate the operation (step S308: Yes), the MDS in charge of the directory to be deleted terminates the directory deletion processing and terminates the operation.

### Hardware Configuration

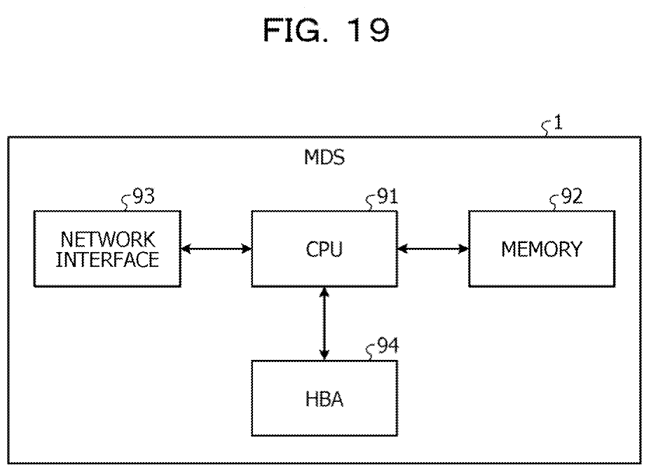

FIG. 19 is a diagram illustrating an example of a hardware configuration of an MDS. As illustrated in FIG. 19, the MDS 1 includes a Central Processing Unit (CPU) 91, a memory 92, a network interface 93, and a Host Bus Adaptor (H BA) 94. The CPU 91 is connected to the memory 92, the network interface 93, and the HBA 94 via a bus.

The HBA 94 is connected to the MDT 2. The HBA 94 is an interface for communication between the CPU 91 and the MDT 2.

The network interface 93 is a communication interface between another MDS 1, the OSS 3, the network 7, and the CPU 91. The network interface 93 implements the function of the communication unit 15 illustrated in FIG. 1.

The memory 92 stores various programs including programs that implement functions of the request reception unit 11, the table management unit 12, the request processing unit 13, and the parent directory management unit 14 illustrated in FIG. 2.

The CPU 91 communicates with the MDT 2 via the HBA 94. Furthermore, the CPU 91 communicates with the another MDS 1, the OSS 3, and the compute node 5 connected to the network 7 via the network interface 93.

The CPU 91 reads various programs including the programs that implement the functions of the request reception unit 11, the table management unit 12, the request processing unit 13, and the parent directory management unit 14 illustrated in FIG. 2 from the memory 92 and develops the read programs so as to form various processes. Then, the CPU 91 implements the functions of the request reception unit 11, the table management unit 12, the request processing unit 13, and the parent directory management unit 14 illustrated in FIG. 2 by executing the various formed processes.

As described above, in the distributed file system according to the present embodiment, the MDS in charge of the file or the directory is determined according to the hash value of the file or the directory. Then, in the distributed file system according to the present embodiment, the metadata of the directory is copied to the another MDS in a case where the metadata up to the parent directory of the file to be created does not exist in the MDS selected at the time when the file is created. In other words, for example, copying of the metadata to the another MDS is delayed. Furthermore, in the distributed file system according to the present embodiment, in a case where the file existing under the directory and the directory are zero, deletion of the metadata of the directory is permitted. Moreover, in the distributed file system according to the present embodiment, whether or not each directory has the metadata is managed by the MDS that has been selected as in charge at the time when the directory is created.

As a result, it is possible to reduce the number of copies of the metadata in a case where the number of MDSs increases, and it is possible to suppress deterioration of directory creation performance due to the increase in the number of MDSs. Furthermore, by deleting the copied metadata of the directory before a directory deletion command is received, it is possible to avoid concentration of processing on the MDS that has received the deletion command, and it is possible to suppress deterioration of directory deletion performance. Therefore, it is possible to enhance processing performance of the distributed file system.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium having stored a metadata management program that causes a computer to execute a process comprising:
managing metadata of a first directory by a first metadata management device; and
copying the metadata of the first directory from the first metadata management device to a second metadata management device in a case where the second metadata management device creates and manages metadata of a second directory or a first file under the first directory.

2. The storage medium according to claim 1, the process further comprising:
deleting the metadata of the first directory held by the second metadata management device in a case where the second directory and the first file do not exist under the first directory of the second metadata management device.

3. The storage medium according to claim 1, the process further comprising:
permitting deletion of the metadata of the first directory managed by the first metadata management device when the first metadata management device does not have the second directory or the first file under the first directory in a case where the second metadata management device does not hold the metadata of the first directory.

4. The storage medium according to claim 3, wherein
the first metadata management device includes a bitmap that indicates a state where the metadata of the first directory is held, and
the process further comprising:
changing a value that corresponds to the second metadata management device in the bitmap to a value that indicates holding in a case where the metadata of the first directory is copied to the second metadata management device;
changing the value that corresponds to the second metadata management device in the bitmap to a value that indicates non-holding in a case where the metadata of the first directory held by the second metadata management device is deleted; and
determining whether or not the second metadata management device holds the metadata of the first directory based on the bitmap.

5. The storage medium according to claim 1, wherein
devices that respectively manage the first directory, the second directory, and the first file are determined based on hash values of the first directory, the second directory, and the first file.

6. An information processing apparatus in a distributed file system comprising:
a memory; and
a processor coupled to the memory and configured to perform a process including:
creating and managing directories and files, and
acquiring metadata of a first directory from another information processing apparatus included in the distributed file system in a case where the metadata of the first directory is managed by the another information processing apparatus and when metadata of a second directory or a file under the first directory that is created and managed by the creating and managing.

7. An information processing apparatus comprising:
a memory storing instructions; and
a processor, coupled to the memory, that executes the instructions to perform a process comprising:
receiving a command;
determining whether the command is a create command or a delete command;
determining, when the command is the create command, whether directory metadata up to a parent directory exists;
creating file metadata when a determination is made that the directory metadata exists;
determining whether lowest layer directory metadata exists in an inquiry target when a determination is made that the directory metadata does not exist; and
creating the directory metadata when a determination is made that the lowest layer directory metadata exists.

8. The information processing apparatus of claim 7, wherein the process further comprises checking access rights of the parent directory when the determination is made that the directory metadata exists.

9. The information processing apparatus of claim 8, wherein the process further comprises updating the directory metadata.

10. The information processing apparatus of claim 7, wherein the process further comprises updating a bitmap of the inquiry target when the determination is made that the directory metadata does not exist.
